(19) United States
(12) Patent Application Publication
(10) Pub. No.: US 2015/0073814 A1
(43) Pub. Date: Mar. 12, 2015

(54) PHYSICAL THERAPY PATIENT ACCOUNTABILITY AND COMPLIANCE SYSTEM

(71) Applicant: Comprehensive Physical Consultants, Inc., Farmington Hills, MI (US)

(72) Inventors: Thomas C. Linebaugh, Highland, MI (US); Brad R. Oppat, Farmington Hills, MI (US)

(73) Assignee: Comprehensive Physical Consultants, Inc., Farmington Hills, MI (US)

(21) Appl. No.: 14/020,389

(22) Filed: Sep. 6, 2013

(51) Int. Cl. G06F 19/00

(52) U.S. Cl. CPC G06F 19/3481
USPC 705/2

(57) ABSTRACT

A patient accountability and compliance system includes a patient computer with a patient tailored treatment program, the patient computer operable to receive a patient input. A patient compliance sensor in communication with the patient computer to receive a measure patient physical therapy activity and a therapist computer in communication with the patient computer operable to the therapist computer receive the measured patient physical therapy activity and the patient input to correlate patient compliance with the patient tailored treatment program.

### BACKGROUND

The present disclosure relates to a patient accountability and compliance system, and more particularly to a system and method which permit remote patient interaction and compliance identification.

Physical therapy has often been described as an art, rather than a science. The therapist patient initial evaluation determines potential causes of pain and dysfunction to develop a treatment plan to address potential causes and goals based on potential expectations for pain reduction and return to function. Patients typically spend 2-3 hours/week with a therapist. One of the primary aspects of the therapists' job is to instruct the patient as to what needs to be done at home to have the greatest chance for a full recovery. As patients are seen over time, usually weeks at a time, the patient is typically separated into two groups using subjective (functional questionnaires) and objective (muscle testing, range of motion measurements, gait observations) data: group 1—progressing; and group 2—not progressing (plateaued or deteriorating)

One difficulty in the determination of treatment efficacy is the reliance on the patient following home instructions as the success or failure of a treatment often relies on a patient's self-reported compliance.

### SUMMARY

A patient compliance system according to one disclosed non-limiting embodiment of the present disclosure includes a patient computer with a patient tailored treatment program, the patient computer operable to receive a patient input. A patient compliance sensor in communication with the patient computer to receive a measure patient physical therapy activity and a therapist computer in communication with the patient computer operable to the therapist computer receive the measured patient physical therapy activity and the patient input to correlate patient compliance with the patient tailored treatment program.

Remote review of data and remote communication with each patient, via real-time video conferencing, focuses resources to facilitate improved physical therapy outcomes at lower costs.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic block diagram of a physical therapy patient compliance system; and

FIG. 2 is a schematic block diagram of a procedure for physical therapy compliance via the physical therapy patient compliance system of FIG. 1;

FIG. 3 is a screenshot from a patient computer of the physical therapy patient compliance system which shows daily physical therapy;

FIG. 4 is a screenshot from the patient computer of the physical therapy patient compliance system which shows task for the selected physical therapy day; and

FIG. 5 is a screenshot from the patient computer of the physical therapy patient compliance system which shows example patient feedback;

### DETAILED DESCRIPTION

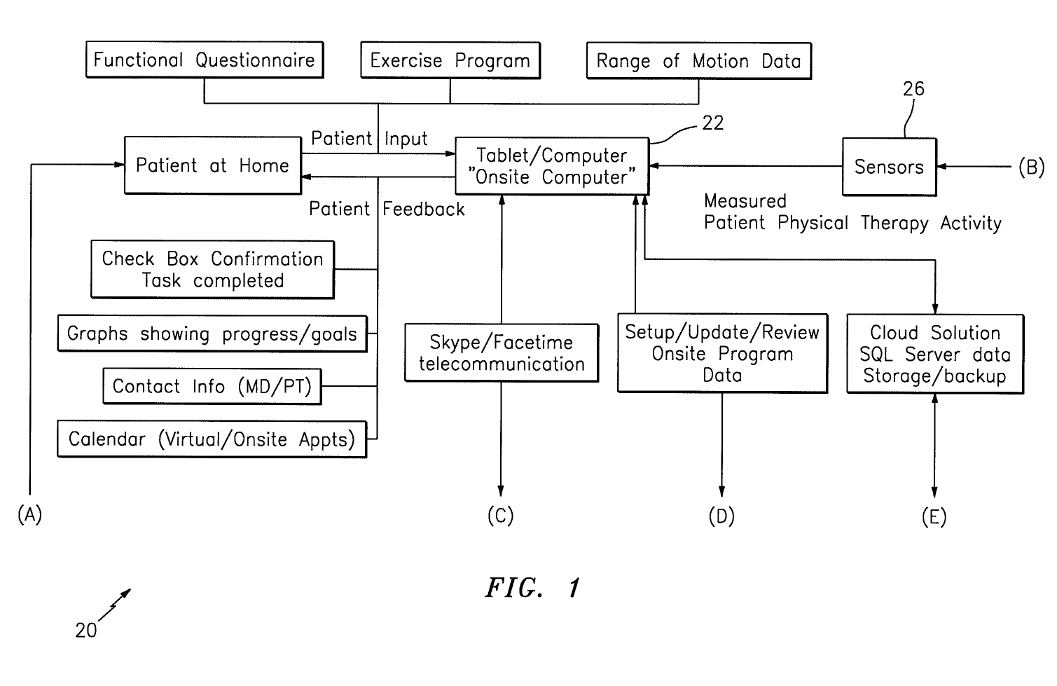

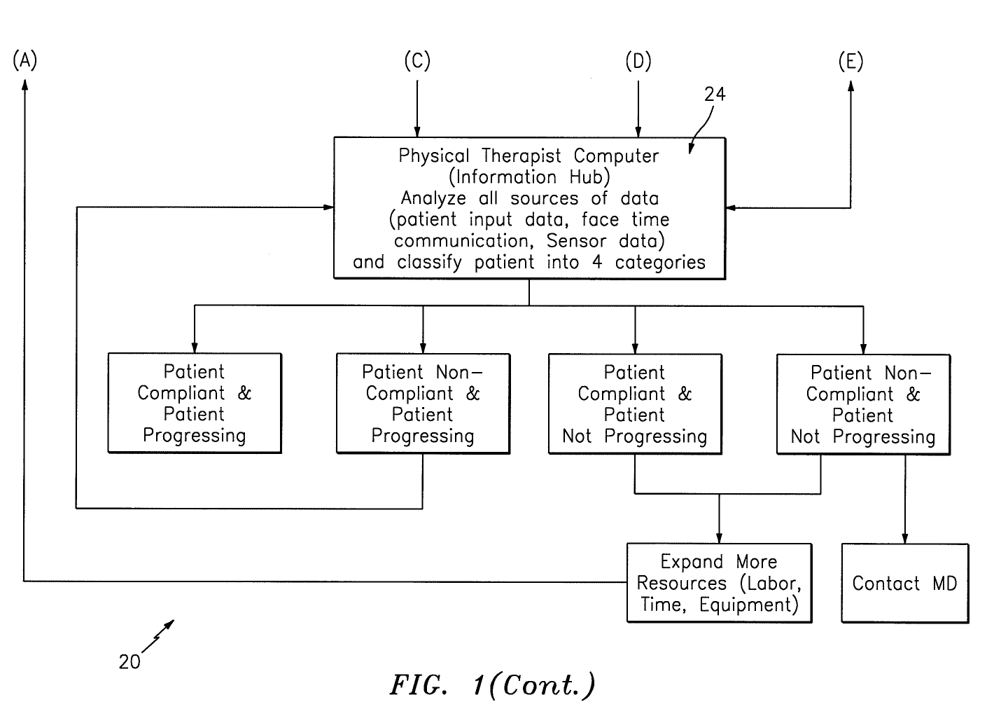

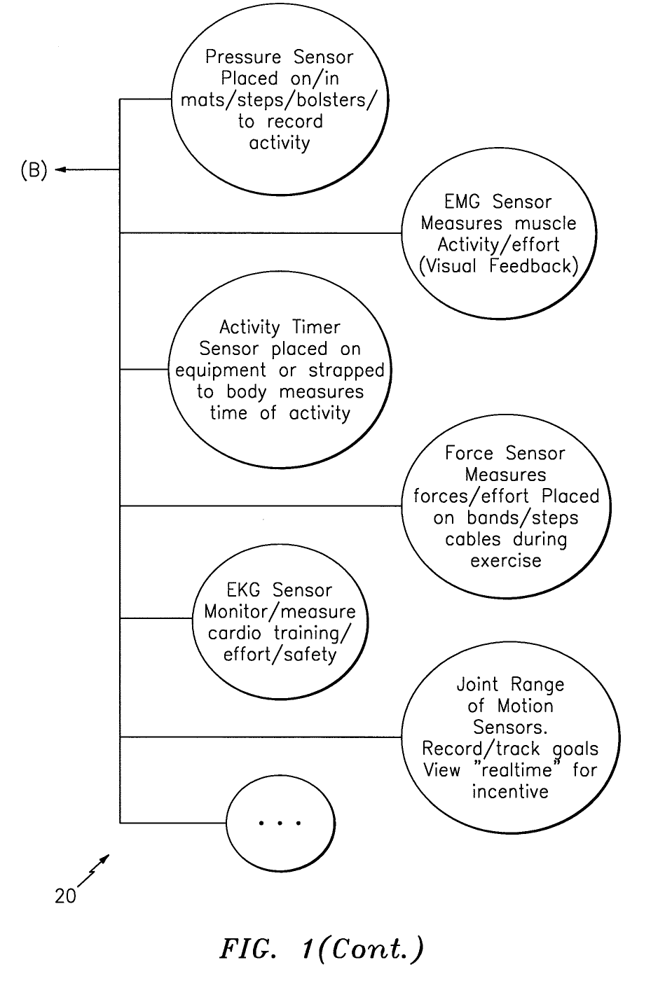

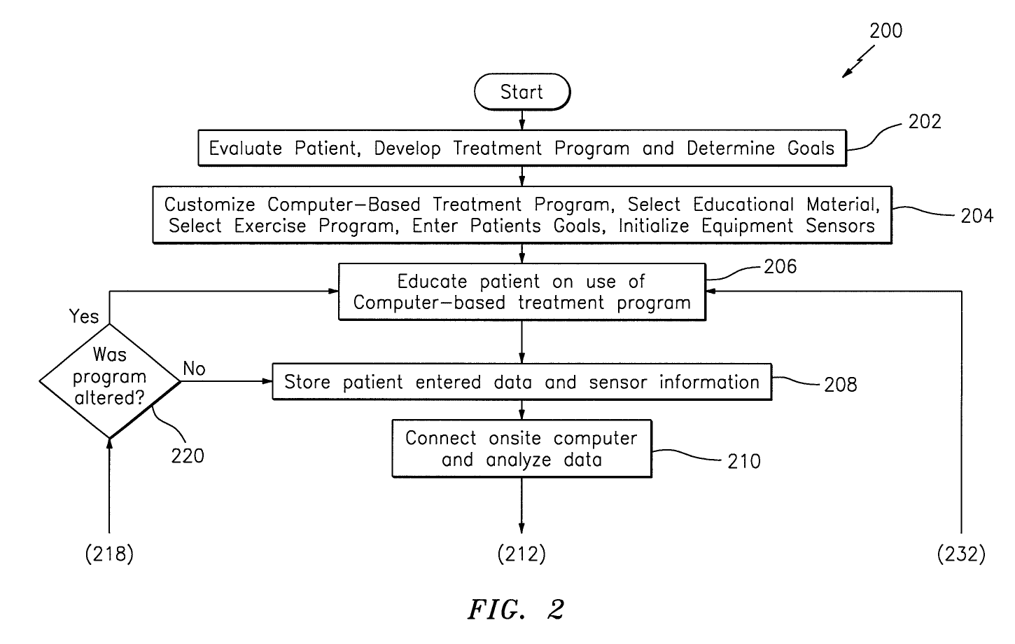

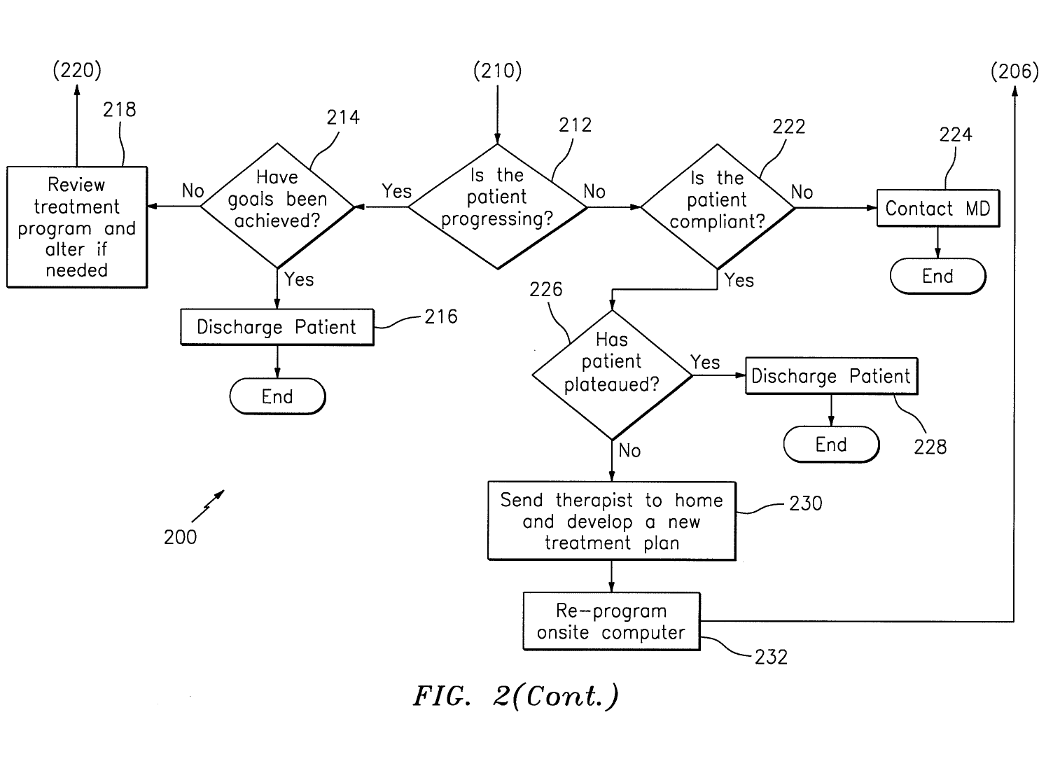

FIG. 1 schematically illustrates a patient compliance system 20. The system 20 generally includes an onsite computer/tablet, i.e., a patient computer 22, a therapist computer 24, and one or more patient compliance sensors 26. The functions of the patient compliance system 20 are disclosed in terms of functional block diagrams (FIG. 2), and it should be understood by those skilled in the art with the benefit of this disclosure that these functions may be enacted in either dedicated hardware circuitry or programmed software routines capable of execution in a microprocessor based electronics control embodiment such as the patient computer 22 and/or therapist computer 24.

The patient computer 22 may include local data storage that includes, but is not limited to, patient demographics, functional questionnaire data, range of motion/strength measurements, treatment goals, contact information, written and video instructions, exercise logs, sensor logs, etc., and are secured to achieve HIPPA regulations.

The therapist computer 24 may communicate with multiple patient computers via, for example, the internet or VPN to facilitate case load management of multiple patients by a single therapist. Further, a “cloud” may be used as a data storage center (SQL Server) accessible by the therapist computer 24. Various “real time” visual and auditory communication systems may also be utilized to communicate between the patient computer 22 and the therapist computer 24.

The patient compliance sensors 26 are utilized to verify patient compliance in combination with patient input to the patient computer 22. That is, the patient compliance sensors 26 provide objective measured physical therapy activity. For example, range of motion measurements of the knee can be taken with the sensors 26 and compared to patient input using, for example, a goniometer.

Each patient compliance sensor 26 may be a wireless sensor that has a unique signal to permit communication between multiple sensors and the patient computer 22. The patient compliance sensors 26 may be placed on exercise equipment such as bikes, arm pulleys, total gyms, treadmills, etc., and/or also attached to the patient, e.g., an activity timer sensor is strapped to a patient's ankle, wrist, trunk, etc., to record the length of exercise time, range of motion, etc. Further, force platforms and pressure sensing mats that measure patient activity may also be utilized.

In another disclosed non-limiting embodiment, the patient compliance sensors 26 measures movement patterns in three planes via, for example, a Triaxial Accelerometer. Triaxial accelerometers may also be used to distinguish certain movement patterns that correlate with a specific exercise to further assist determination of patient compliance.

Still other patient compliance sensors 26 include but are not limited to EMG and EKG type sensors. An EKG (Electromyogram) records the electric currents associated with muscular activity to track the intensity of the muscle contraction (effort) along with giving feedback to the patient as an incentive to increase their effort. An EKG (Electrocardiogram) records electrical activity of the heart to measure patient effort and also as a safety check to ensure the patient works out within a safe range.

With reference to FIG. 2, one disclosed non-limiting embodiment of the patient compliance method 200 facilitated by the patient compliance system 20 initially includes a physical therapist evaluation of the patient during a home visit pursuant to a physical therapy order from the physician. The therapist develops a treatment program and determine patient goals specific to that patient (step 202). Advantageously, this may be the only home visit which necessitates the therapist.

Once evaluated, the therapist will then customize a computer-based patient tailored treatment program on the patient computer 22 (step 204) to, for example, select educational material, select exercise programs, enter patient goals and initialize the sensors 26. That is, the therapist need only select from predefined educational materials, exercise programs and patient goals to create the customized patient tailored treatment program on the patient computer 22. The treatment program readily adds new exercises, video, patient information, etc.

to address the many diseases that may be treated.

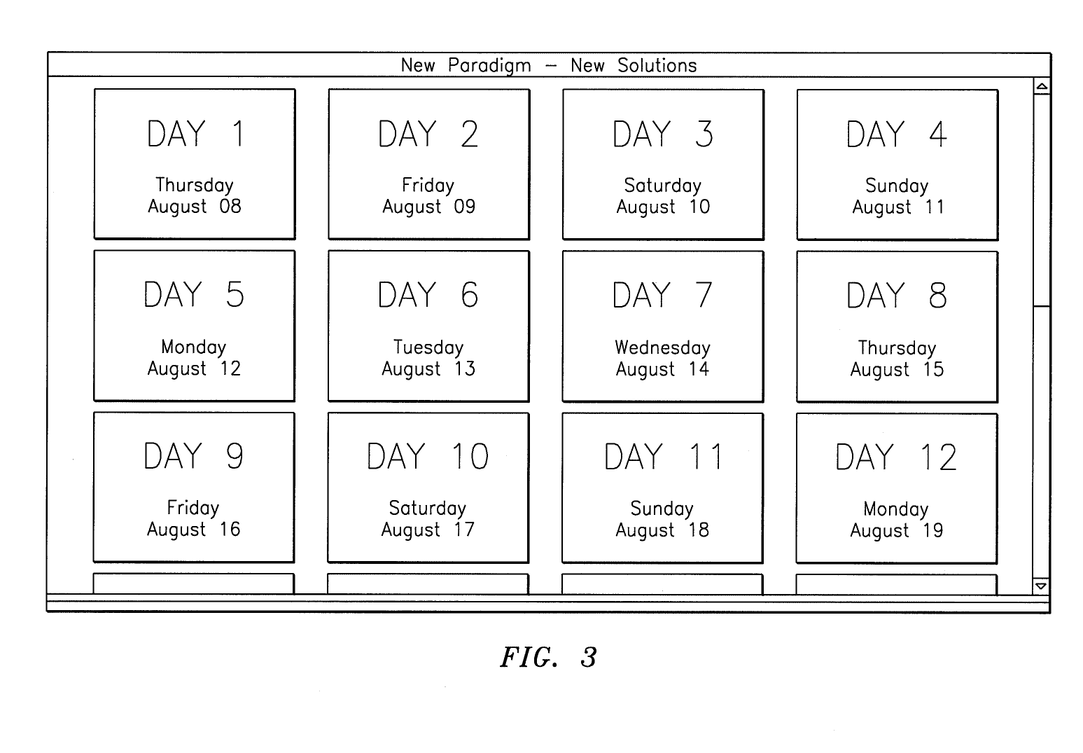

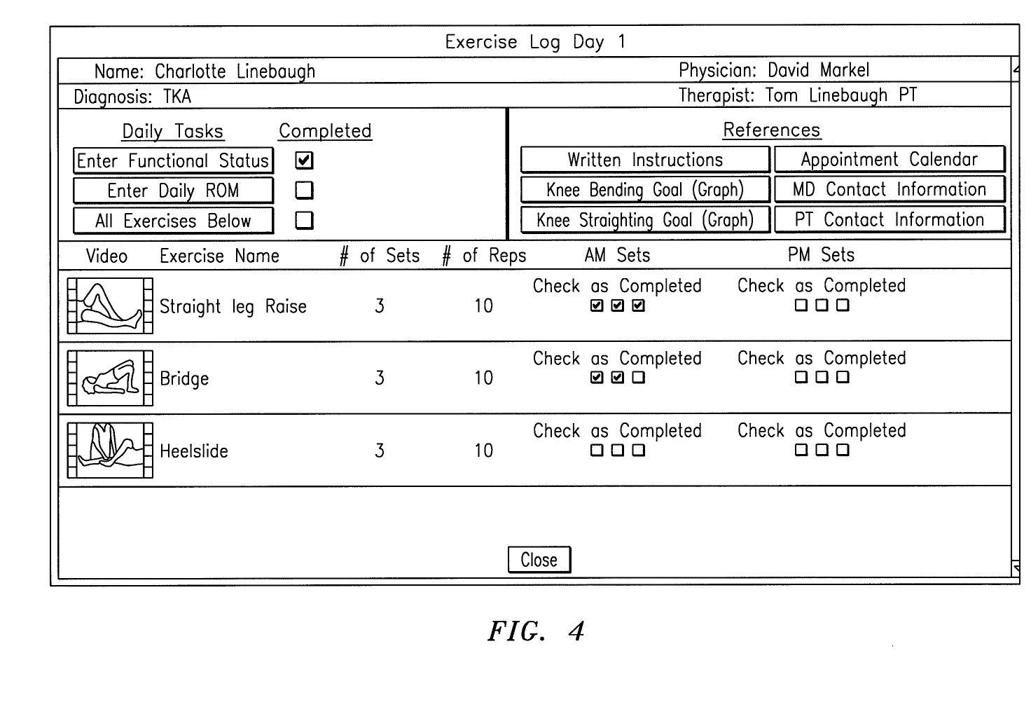

The patient tailored treatment program on the patient computer 22 may be scheduled to be reviewed on the first home performed physical therapy day, and/or may be set up to be reviewed a second time and/or on subsequent days. Links to this data may be provided on a “daily task” list (FIG. 4). Once the patient selects the day, the information is displayed, and a record of when and how long the page was opened is recorded to facilitate determination of patient compliance. That is, the actual time to review/watch the information is correlated with the actual time the patient spends with the patient computer 22 to determine actual compliance.

Such cross-referencing and correlation is utilized throughout each aspect of the customized patient tailored treatment program.

The therapist then educates the patient on the patient tailored treatment program (step 206). During this initial home visit the therapist will review their finding with the patient and explain their treatment program, goals, instruction for use of the patient computer, stressing completion of daily tasks, video conferencing, etc.

An exercise routine for the customized computer-based treatment program on the patient computer 22 is then developed and segregated into daily tasks such as, straight leg raise, bridge and heel slide (FIG. 4). Examples of exercise routines may include strengthening, endurance, range of motion/flexibility, proprioception and/or balance activities. Written instructions and video files ensure the patient understands how to perform each exercise. That is, the patient utilizes the patient computer 22 as a guide though the daily physical therapy for the patient tailored treatment program.

As the patient performs the patient tailored treatment program, patient input and measured data from the sensors 26 are stored on the patient computer 22 (step 208). That is, as the patient completes the daily tasks of the patient tailored treatment program, the patient provides patient input via, for example, check boxes, each patient input is time-stamped and stored. The sensors 26 also communicate with the patient computer 22 to record related objective measured data, such as time on exercise equipment, forces applied, heart rate, EMG activity, strength of muscle activity, etc. Again, the patient inputs to the patient computer and measured physical therapy activity by the sensors 26 are correlated and thereby utilized to determine actual patient compliance.

The customized patient treatment program provides the daily task list for the specific patient. Daily tasks can include, but are not limited, to:

Functional Questionnaire-patient input: completing functional questionnaires then box checked as completed. Therapist reviews the change in function over predetermined time intervals, e.g., start of care, 30 days, discharge, etc. This data is commonly referred to as outcome measures.

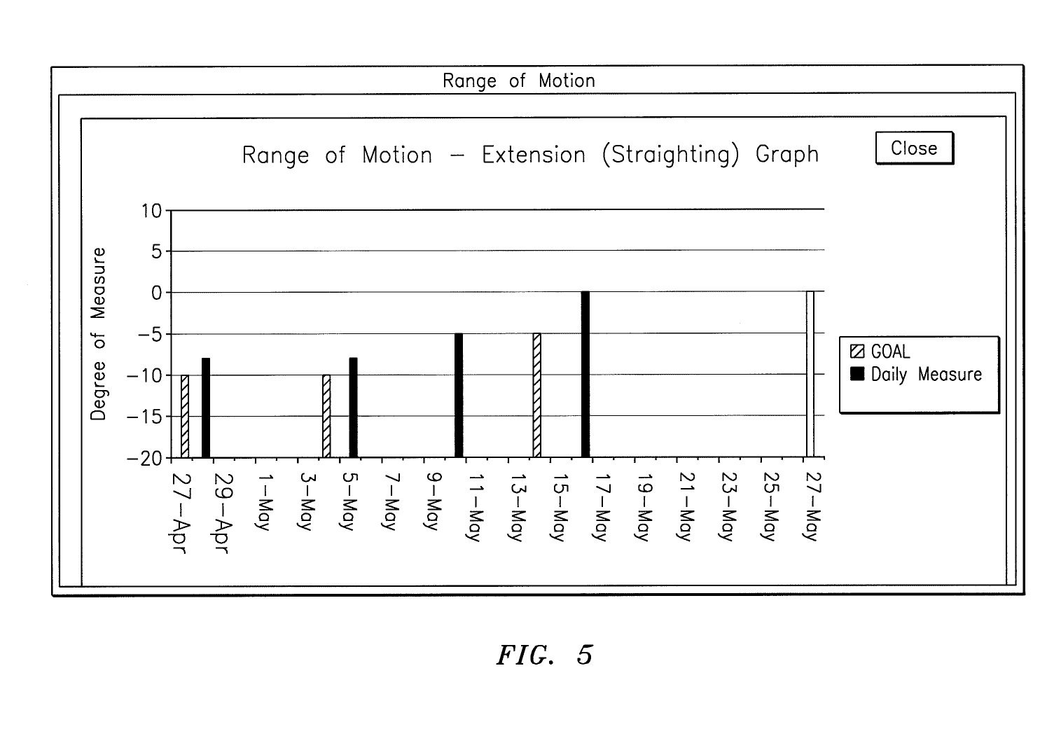

Exercise Program-patient input: check boxes as sets of exercises are completed. Patient input: patient review of new exercise instructions, then check boxes as patient has reviewed. Patient input: Range of motion (ROM) entered by patients and patient views the current ROM and follow progress in graph fowl on the patient computer 22 (FIG. 5). Patient input: patient clicks on links that displays instructions specific to their condition and information explains how to correctly perform activities of daily living, exercises, edema control, etc. The information is also used to protect the patient from harm including, infection control, proper body mechanics, risky body positions, etc. For example, instructions on how to safely get in/out of bed after a total hip arthroplasty or movements that need to be avoided to prevent hip dislocation. Data collected from time stamps associated with such patient inputs is thereby used to determine when and what was or was not viewed by the patient.

Other Feedback-patients provided with a calendar function to view days and times scheduled to communicate with their therapists either virtually or in person.

The patient may be required to press a start button prior to an exercise in the patient tailored treatment program and/or fill a check box after completion of the exercise as part of the patient input. The patient may also be required to fasten sensors 26 on their body before starting the exercise. Such patient input is timed-stamped and stored, along with the measured data from the sensors 26.

The combination of patient input data and measured data from the sensors 26 are used to determine patient compliance. For example, if a patient checks a box that indicates ten minutes were completed on an exercise bike, a heart rate sensor 26 along with an equipment sensor 26 on the bike may be utilized to correlate and thereby confirm the ten minutes of activity.

As the patient interacts with the patient computer 22 the therapist may, in “real time”, view patient input along with data from the patient compliance sensors 26. That is, the therapist may remotely review and monitor patient progress and remotely change the patient tailored treatment program. For example, the therapist may also use video conferencing to view the patient during their exercise routine and give immediate feedback with regard to their technique. Advantageously, the therapist need not perform a home visit with the attendant costs, but will remotely connect to the patient computer 22 to analyze data and adjust the patient tailored treatment program as required.

All data input to the patient computer 22—either by the patient or by the sensors 26 are utilized to confirm the time and intensity of patient compliance. That is, the therapist can identify non-correlating data such as an exercise check box selected but no operational time is reported from a sensor 26 on the equipment. Alternately, such correlation may be automated and the therapist alerted to potential discrepancies.

The correlated data allows the therapist to remotely determine if the patient is progressing (step 212) such that the patient may then be placed into, for example, one of four categories:

1. Compliant and Progressing—the expected response to treatment that should result in the patient achieving their goals;

2. Non-compliant and Progressing—patient is still progressing towards goals, but will need further feedback (written, email, phone call, etc) to increase compliance;

3. Compliant and Not-Progressing—patient is following the treatment plan developed for their condition, but is not progressing as expected. The therapist will need to determine if further assessment, an updated patient tailored treatment plan and/or more hands on therapy will be required for the patient to attain their goals; or

4. Non-Compliant and Not-Progressing - patient is not progressing as expected, but also has not been compliant. This patient will require special attention, feedback, and hands-on therapy. If the patient continues to stay in this category, the patient would be discharged from therapy and the physician would be notified.

If the patient is progressing as expected and has reached their goals (step 214) the patient is discharged from therapy (step 216).

Otherwise, the therapist reviews the data (step 218) and decides if the patient tailored treatment program needs to be altered (step 220). It is then determined if the patient requires additional time on the current patient tailored treatment program(step 208), or the patient tailored treatment program needs to be altered and the patient will need to be educated on the updated patient tailored treatment program (step 206).

If the patient is not progressing as expected, the therapist will need to decide if the patient has been compliant (step 222). If the patient has not been compliant the physician is contacted with respect to the situation and the patient may be discharged (step 224).

If the patient continues to progress towards their goals while being non-compliant, the therapist then determines if patient progress has plateaued (step 226) and, if so, the patient is discharged (step 228). If, however, the therapist determines that the patient has more potential to progress (step 230) the therapist can review the progress and develop an updated patient tailored treatment program(step 232) and accordingly updates the patient computer 22 (step 232). The therapist then educates the patient on the new tailored treatment program.(step 206).

Remote review of data and remote communication with each patient focuses resources to facilitate improved physical therapy outcomes at lower costs.

The use of the terms “a” and “an” and “the” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other. It should be appreciated that relative positional terms such as “forward,” “aft,” “upper,” “lower,” “above,” “below,” and the like are with reference to the normal operational attitude of the vehicle and should not be considered otherwise limiting.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be appreciated that like reference numerals identify corresponding or similar elements throughout the several drawings. It should also be appreciated that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within Various non-limiting embodiments are disclosed herein, however, one of ordinary skill in the art would recognize that various modifications and variations in light of the above teachings will fall within the scope of the appended claims It is therefore to be appreciated that within the scope of the appended claims, the disclosure may be practiced other than as specifically described. For that reason the appended claims should be studied to determine true scope and content.

What is claimed:

1. A patient compliance system comprising:
a patient computer with a patient tailored treatment program, said patient computer operable to receive a patient input;
a patient compliance sensor in communication with said patient computer to receive a measure patient physical therapy activity; and
a therapist computer in communication with said patient computer operable to said therapist computer receive said measured patient physical therapy activity and said patient input to correlate patient compliance with the patient tailored treatment program.

2. The system as recited in claim 1, wherein said patient compliance sensor is attached to a patient.

3. The system as recited in claim 1, wherein said patient compliance sensor is attached to an exercise device.

4. The system as recited in claim 1, wherein said patient compliance sensor measures a patient range of motion.

5. The system as recited in claim 1, wherein said patient compliance sensor measures a patient heart rate.

6. The system as recited in claim 1, wherein said patient input includes a check box.

7. The system as recited in claim 1, wherein said patient computer is in wireless communication with said patient compliance sensor.

8. The system as recited in claim 1, wherein said patient compliance sensor measures movement patterns in three planes.

9. The system as recited in claim 8, wherein said patient compliance sensor is a Triaxial Accelerometer.

10. A method of monitoring compliance of a physical therapy patient to a patient tailored treatment program comprising:
measuring a patient physical therapy activity to obtain a measured patient physical therapy activity;
wirelessly communicating the measured patient physical therapy activity to the patient computer;
receiving a patient input to a patient computer; and
communicating the measured patient physical therapy activity and the patient input to the to a therapist computer to correlate patient compliance with a patient tailored treatment program.

11. The method as recited in claim 10, further comprising measuring a range of motion as the patient physical therapy activity.

12. The method as recited in claim 10, further comprising measuring a time of the patient physical therapy activity.

13. The method as recited in claim 10, further comprising correlating two or more patient physical therapy activities to identify compliance.

14. The method as recited in claim 10, further comprising correlating the patient physical therapy activity with the patient input.

15. The method as recited in claim 10, wherein receiving the patient input to the patient computer includes the checking of a check box.

16. The method as recited in claim 15, wherein the checking of a check box is correlated to the measured patient physical therapy activity.

17. The method as recited in claim 16, wherein the checking of a check box is correlated to a heart rate of the patient.

18. The method as recited in claim 16, wherein the checking of a check box is correlated to a physical therapy equipment operational time.

19. The method as recited in claim 10, wherein receiving the patient input to the patient computer includes measuring a time a patient views data on the patient computer.
